(19) United States
(12) Patent Application Publication
(10) Pub. No.: US 2026/0172221 A1
(43) Pub. Date: Jun. 18, 2026

(54) ELECTRONIC DEVICE AND SERVER DEVICE FOR PROCESSING DATA

(71) Applicant: CRYPTO LAB INC., Seoul (KR)

(72) Inventors: Junbum Shin, Suwon-si (KR); Jungjoo Seo, Seoul (KR); Gun Jun Lee, Incheon (KR); Yeong Hyeon Kim, Seoul (KR); Jongmin Choi, Seoul (KR)

(21) Appl. No.: 19/357,366

(22) Filed: Oct. 14, 2025

(30) Foreign Application Priority Data
Oct. 14, 2024 (KR) 10-2024-0139815
Oct. 10, 2025 (KR) 10-2025-0146267

(51) Int. Cl. H04L 9/00; H04L 9/08

(52) U.S. Cl. CPC H04L 9/008; H04L 9/0825; H04L 9/0861

(57) ABSTRACT

An electronic apparatus is disclosed. The electronic apparatus includes a communication interface, a memory, and a processor, in which the processor is configured to generate a public key and a secret key for homomorphic encryption, respectively, and store the public key and secret key in the memory, transmit a homomorphic ciphertext obtained by encrypting target information to a server apparatus, transmit a query to the server apparatus, and when an operation result obtained by operating the query with pieces of information within an indexing range identified based on a preset classification criterion among a plurality of pieces of information stored in the server apparatus is transmitted from the server apparatus, decrypt the operation result using the secret key, identify an order of the target information based on the decrypted operation result, and transmit information on the identified order to the server apparatus to acquire an identifier corresponding to the target information.

### TECHNICAL FIELD

Apparatuses and methods consistent with the disclosure relate to an electronic apparatus and server apparatus for processing homomorphically encrypted data, and methods thereof.

### BACKGROUND ART

With the development of an electronic technology, various types of electronic apparatuses have been developed. The electronic apparatus is linked with external devices, such as a server apparatus, to provide various services.

The server apparatus may provide various services in response to each user's request while storing information about multiple users.

In the case of using services linked with the server apparatus, user convenience may significantly increase. However, there is a problem with the potential for personal information of a user to be leaked through the server apparatus. For example, when a user transmits and stores their face photos, etc., to the server apparatus, there is a possibility that the user's face photo may be leaked during the process of being transmitted to the server apparatus or from the server apparatus itself.

Therefore, there is a growing need for a technology that may easily utilize information stored on the server apparatus while maintaining the security of the information

### DISCLOSURE OF DISCLOSURE

### Solution to Problem

The present disclosure has been made in view of the above-described need, and an object of the present disclosure provides a server apparatus capable of using data in a secured state by using an identifier for homomorphically encrypted data, and a data processing method.

In accordance with an aspect of the disclosure, an electronic apparatus includes: a communication interface; a memory; and a processor, in which the processor is configured to generate a public key and a secret key for homomorphic encryption, respectively, and store the public key and secret key in the memory, transmit a homomorphic ciphertext obtained by encrypting target information using the public key or the secret key to the server apparatus via the communication interface, transmit a query for searching for an identifier of the target information to the server apparatus via the communication interface, and when pieces of information within an indexing range are identified based on a preset classification criterion among a plurality of pieces of information stored in the server apparatus and an operation result obtained by operating the query is transmitted from the server apparatus, decrypt the operation result using the secret key, identify an order of the target information based on the decrypted operation result, and transmit information on the identified order to the server apparatus to acquire an identifier corresponding to the target information, and the query is plaintext or a homomorphic ciphertext obtained by homomorphically encrypting the plaintext.

In accordance with another aspect of the disclosure, a server apparatus includes: a communication interface; a memory storing a plurality of pieces of homomorphically encrypted target information and a plurality of identifiers corresponding to the plurality of pieces of target information; and a processor, in which the processor is configured to: when a query is received from an electronic apparatus via the communication interface, specify an indexing range based on preset classification criteria, and operate the pieces of target information within the indexing range among the plurality of pieces of target information and the query, respectively, transmit an operation result to the electronic apparatus via the communication interface, and when information on an order of the target information corresponding to the query within the operation result is received from the electronic apparatus, transmit an identifier corresponding to the order to the electronic apparatus via the communication interface.

In accordance with still another aspect of the disclosure, a data processing method of an electronic apparatus includes: generating a public key and a secret key for homomorphic encryption, respectively, and storing the public key and secret key; transmitting a homomorphic ciphertext obtained by encrypting target information using the public key or the secret key and first indexing information for the homomorphic ciphertext to a server apparatus; transmitting a query for searching for an identifier of the target information and second indexing information for the query to the server apparatus; when an operation result between pieces of information within a range corresponding to the second indexing information among a plurality of pieces of information stored in the server apparatus and the query is received from the server apparatus, decrypting the operation result using the secret key; and identifying an order of the target information based on the decrypted operation result and transmitting information on the identified order to the server apparatus to acquire an identifier corresponding to the target information.

In accordance with yet another aspect of the disclosure, a data processing method of a server apparatus includes: storing a plurality of pieces of homomorphically encrypted target information and a plurality of identifiers corresponding to the plurality of pieces of target information; when a query and indexing information corresponding to the query are received from an electronic apparatus, operating pieces of target information within a range corresponding to the indexing information among the plurality of pieces of target information and the query, respectively, and transmitting the operation result to the electronic apparatus; and when information on an order of the target information corresponding to the query within the operation result is received from the electronic apparatus, transmitting an identifier corresponding to the order to the electronic apparatus.

According to various embodiments of the present disclosure, a user may easily confirm whether there is his/her desired information and use the information while maintaining the security of target information stored in the server apparatus.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram for describing operations of an electronic apparatus and a server apparatus according to at least one embodiment of the present disclosure;

FIG. 2 is a block diagram illustrating a configuration of the electronic apparatus according to at least one embodiment of the present disclosure;

FIG. 3 is a block diagram illustrating a configuration of the server apparatus according to at least one embodiment of the present disclosure;

FIG. 4 is a timing diagram for describing operations of the electronic apparatus and the server apparatus according to at least one embodiment of the present disclosure;

FIGS. 5 to 9 are diagrams for describing various methods of generating indexing information;

FIG. 10 is a flowchart for describing a data processing method of an electronic apparatus according to at least one embodiment of the present disclosure;

FIG. 11 is a flowchart for describing a data processing method of a server apparatus according to at least one embodiment of the present disclosure;

FIG. 12 is a diagram for describing an entire indexing hierarchy for target information managed by a server apparatus according to another embodiment of the present disclosure; and

FIG. 13 is a timing diagram for describing the operations of the electronic apparatus and the server apparatus according to the embodiment of FIG. 12.

### MODE FOR DISCLOSURE

Encryption/decryption may be applied to an information (data) transmission process performed in the present disclosure, if necessary, and all expressions describing the information (data) transmission process in the present disclosure and claims should be interpreted as including cases of encryption/decryption even if not separately stated.

In the present disclosure, expressions such as “transmission (delivery) from A to B” or “A receiving from B” include transmission (delivery) or reception with another medium included therebetween, and do not necessarily express only what is directly transmitted (delivered) or received from A to B.

In the description of the present disclosure, the order of each step should be understood as non-limiting unless the preceding step needs to be logically and temporally performed necessarily before the following step. In other words, except for the above exceptional cases, even if the process described as the following step is performed before the process described as the preceding step, the nature of the disclosure is not affected, and the scope should also be defined regardless of the order of the steps. In this specification, “A or B” is defined to mean not only selectively indicating either one of A and B, but also including both A and B.

In addition, in the present disclosure, the term “include” has a meaning encompassing further including other components in addition to elements listed as included.

In the present disclosure, only essential components necessary for the description of the present disclosure are described, and components unrelated to the essence of the present disclosure are not mentioned. In addition, it should not be interpreted as an exclusive meaning that includes only the mentioned components, but should be interpreted as a non-exclusive meaning that may include other components.

In the present disclosure, the term “value” is defined as a concept that includes not only a scalar value but also forms such as a vector or a polynomial.

Mathematical operations and calculations of each step of the present disclosure to be described below may be implemented as computer operations by the known coding method and/or coding designed to suit the present disclosure to perform the corresponding operation or calculation.

Specific equations to be described below are illustratively described among possible alternatives, and the scope of the present disclosure should not be construed as being limited to equations mentioned in the present disclosure.

For convenience of description, in the present disclosure, a notation is defined as follows.
a←D: Select element (a) according to distribution (D)
s1, s2 ∈R: Each of S1 and S2 is an element belonging to set R.
mod(q): Modular operation with element q
   |⋅|: Round-off internal value

Hereinafter, various embodiments of the present disclosure will be described in detail with reference to the accompanying drawings.

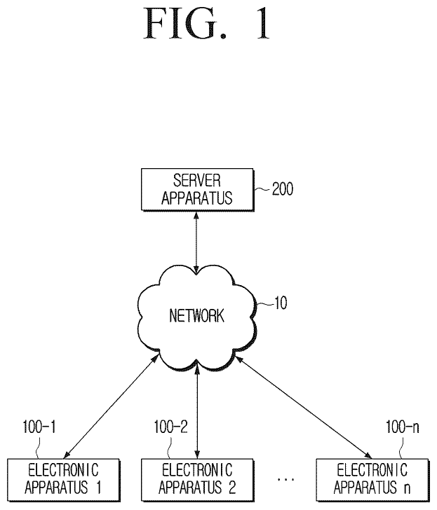

FIG. 1 is a schematic diagram for describing operations of an electronic apparatus and a server apparatus according to at least one embodiment of the present disclosure. Referring to FIG. 1, a plurality of electronic apparatuses 100-1 to 100-n may communicate with a server apparatus 200 via a network 10.

The network 10 may be implemented as various types of wired/wireless communication networks, broadcast communication networks, optical communication networks, cloud networks, etc. FIG. 1 illustrates a state in which each electronic apparatus 100-1 to 100-n is connected to a single server apparatus 200 via the network 10, but the present disclosure is not limited thereto. Each electronic apparatus may also be directly connected to the server apparatus 200 via a method such as Wi-Fi, Bluetooth, or near field communication (NFC) without a separate intermediary.

FIG. 1 illustrates a single server apparatus 200, but at least one server apparatus 200 may be implemented, and may be implemented as a web server or a cloud server connectable to the Internet.

The server apparatus 200 may store target information provided by each electronic apparatus 100-1 to 100-n by matching the target information with an identifier. The pieces of target information are a homomorphic ciphertext. The pieces of target information may be transmitted after being homomorphically encrypted by each electronic apparatus 100-1 to 100-n.

The server apparatus 200 may generate identifiers for the pieces of target information and then store the target information by matching the identifiers with the target information.

The target information may include various pieces of information related to the electronic apparatuses 100-1 to 100-n or their users. For example, the target information may include not only various types of data created by the user, such as text, images, and photos, but also various types of information, such as a name, unique number, address, contact information, email address, work information, bank account number, social network service (SNS) ID, password, electronic apparatus type, and IP address. Furthermore, the target information may include various types of information not disclosed above.

Each electronic apparatus 100-1 to 100-n may generate a public key and a secret key for homomorphic encryption, respectively and then use the public key to homomorphically encrypt the target information.

By transmitting the homomorphically encrypted target information to the server apparatus 200, security may be maintained even if the target information is leaked during transmission. Furthermore, since the target information is stored in the server apparatus 200 in the homomorphically encrypted state, the security may be maintained even for an administrator of the server apparatus 200.

Users of each electronic apparatus 100-1 to 100-n may use various services by using the identifier assigned to the target information while the homomorphically encrypted target information is stored in the server apparatus 200. For example, users may confirm whether the target information they wish to search for is stored in the server apparatus 200.

Specifically, when users wish to search for specific target information, they may input a query to search for that target information to their electronic apparatus 100. The query may be part or all of the target information. For example, when the target information includes the name “KIM” in whole or in part, the query may be entered as “KIM.”

The electronic apparatus also homomorphically encrypts the query using the public or secret key and then transmits the query to the server apparatus 200. The query does not necessarily need to be encrypted with the same key as the target information, but may be encrypted with different keys. For example, the target information and the query may be encrypted respectively using different public keys generated from the same secret key.

For convenience of description, the data obtained by homomorphically encrypting the target information is referred to as a first homomorphic ciphertext, and the data obtained by homomorphically encrypting the query is referred to as a second homomorphic ciphertext below.

When the homomorphically encrypted query is transmitted to the server apparatus 200, the server apparatus 200 performs an operation on at least a portion of the entire stored target information and the query, i.e., the second homomorphic ciphertext, and transmits the operation result to the electronic apparatus 100. For example, the server apparatus 200 may calculate the similarity between at least a portion of the entire target information and the second homomorphic ciphertext. While an inner product operation may be performed to calculate the similarity, the present disclosure is not limited thereto and various other operations may be performed.

The server apparatus 200 may add the calculated result values to acquire the operation result. The operation result may include private membership test (PMT) result data. The PMT is data indicating whether an item corresponding to a user-entered query is included among a plurality of pieces of target information.

When the second target information among the pieces of target information is identical to the query, if the similarity calculation results are sequentially added, only the bit corresponding to the second target information becomes 1, and all bits corresponding to the remaining target information become 0.

When the operation result is received, the electronic apparatus 100 decrypts the operation result using the secret key. For example, when the PMT result data is received, the second bit value among the decrypted data becomes 1, and the rest becomes 0. Therefore, the electronic apparatus 100 may determine that the server apparatus 200 is storing the target information corresponding to the query, and that the storage order is second.

The electronic apparatus may transmit information on the storage order of the target information to the server apparatus 200. The server apparatus 200 may transmit the identifier corresponding to the order information to the electronic apparatus 100. The identifier may be stored in the server apparatus 200 in plaintext or ciphertext.

The electronic apparatus 100 may share the received identifier with another apparatus or a specific application. Alternatively, the electronic apparatus 100 may receive the target information itself corresponding to the identifier from the server apparatus 200. That is, when the server apparatus 200 receives a specific identifier or specific order information from the electronic apparatus 100, it may transmit the target information itself corresponding to the identifier or order information to the electronic apparatus 100 in the form of the homomorphic ciphertext.

Meanwhile, when the number or amount of target information is large, it may require considerable resources to search for the target information. For example, when 10 million pieces of target information are stored in the server apparatus 200, if a query for target information search is received from the electronic apparatus 100, the server apparatus 200 should calculate the similarity between the query and the entire target information, resulting in a significant operation burden and significant time consumption.

According to various embodiments of the present disclosure, the electronic apparatus 100 may use indexing information to limit a portion of the search range. For example, when 10 million pieces of target information are classified into five groups, the server apparatus 200 may select a group identified based on preset classification criteria. If each group contains 2 million pieces of target information, the server apparatus 200 only needs to query and operate for the 2 million target information, reducing the operation burden by ⅕.

The indexing information may be generated in various methods and formats depending on the embodiment. The indexing information may be generated to store target information in the server apparatus 200 or in response to a query. For convenience of description, the indexing information generated in relation to target information is referred to as first indexing information, and the indexing information generated in relation to the query is referred to as second indexing information.

Additionally, the classification criteria may be generated and directly stored by each of the plurality of electronic apparatuses 100-1 to 100-n, or transmitted to the server apparatus 200 and stored in the server apparatus 200. Alternatively, the classification criteria may be generated and directly stored by the server apparatus 200, or transmitted to each of the electronic apparatuses 100-1 to 100-n and stored therein.

According to one embodiment, a single electronic apparatus (hereinafter, 100) may generate and store the classification criteria. In this case, the classification criteria may be stored in the electronic apparatus 100 in an unencrypted state. When the electronic apparatus 100 has target information to be stored in the server apparatus 200, it may compare the target information with the stored classification criteria to generate the first indexing information that determines within which indexing range the target information should be stored, and transmit the first indexing information to the server apparatus 200. The server apparatus 200 may store target information in a location corresponding to the first indexing information.

Thereafter, when a query for searching specific information is input, the electronic apparatus 100 may compare a similarity between the query and plurality of previously stored classification criteria, identify an indexing range to be searched based on the comparison results, and generate second indexing information corresponding to the identified indexing range. The electronic apparatus 100 may transmit the query and the second indexing information together to the server apparatus 200. The server apparatus 200 may then specify an indexing range based on the second indexing information and perform operations between the query and information within the indexing range.

According to another embodiment, an electronic apparatus (hereinafter, 100) may generate classification criteria and then transmit the classification criteria to the server apparatus 200, which may then store the classification criteria. In this case, the classification criteria may be provided to the server apparatus 200 in an encrypted state.

When there is target information to be stored in the server apparatus 200, the electronic apparatus 100 may generate first indexing information for the target information and transmit the generated first indexing information to the server apparatus 200. The server apparatus 200 may store target information within an indexing range corresponding to the first indexing information based on the stored classification criteria. Thereafter, when a query for searching for target information is input, the electronic apparatus 100 may transmit the query to the server apparatus 200. The server apparatus may operate the entire stored classification criteria and the query and transmit the operation result to the electronic apparatus 100. The electronic apparatus 100 may decrypt the operation result to identify the classification criteria that are identical or similar to the query among the entire classification criteria and generate second indexing information corresponding thereto. When the electronic apparatus 100 transmits the second indexing information to the server apparatus 200, the server apparatus 200 may operate a query with information within the indexing range corresponding to the second indexing information.

However, it is not necessarily operated as described above. When the electronic apparatus 100 generates the classification criteria and the server apparatus 200 stores the classification criteria, the classification criteria may not be encrypted. In this embodiment, when the electronic apparatus 100 transmits a query for information retrieval, the server apparatus 200 may immediately identify the indexing range based on the second indexing information operated with the previously stored classification criterion and the query.

According to another embodiment, the server apparatus 200 may directly generate the classification criteria and then provide the classification criteria to the electronic apparatus 100 in an unencrypted state. The electronic apparatus 100 may download data regarding the classification criteria from the server apparatus 200 in advance. The electronic apparatus 100 may identify the indexing range based on the classification criteria and transmit the first and second indexing information for specifying the indexing range.

According to another embodiment, the server apparatus 200 may directly generate the classification criteria and then store the classification criteria itself in an unencrypted state. The electronic apparatus 100 may download the classification criteria from the server apparatus 200. In this case, when the electronic apparatus 100 transmits first indexing information corresponding to the target information along with the target information, the server apparatus 200 may store the target information within the indexing range corresponding to the first indexing information. Furthermore, when the electronic apparatus 100 transmits second indexing information corresponding to a query along with the query, the server apparatus 200 may compute the query with information within the indexing range corresponding to the second indexing information.

Hereinafter, various embodiments of the present disclosure will be described in detail.

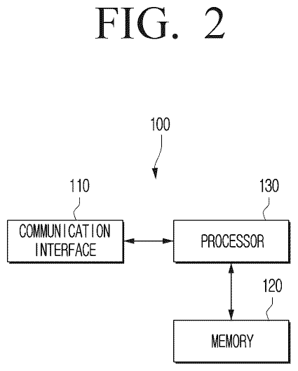

FIG. 2 is a block diagram illustrating a configuration of the electronic apparatus according to at least one embodiment of the present disclosure. The electronic apparatus 100 of FIG. 2 may be one of the plurality of electronic apparatuses 100-1 to 100-n of FIG. 1.

According to FIG. 2, an electronic device 100 according to at least one embodiment of the present disclosure includes a communication interface 110, memory 120, and a processor 130. As described above, the electronic device 100 may be implemented in various forms, and thus, various detailed components may be added. For example, when implemented as a mobile phone, the electronic device 100 may further include a display, a touch sensor, a speaker, a power circuit, and the like.

The communication interface 110 is a component for communicating with various external devices, including the server device 200. The communication interface may transmit and receive various signals and data to and from external devices through various wired and wireless communication methods, such as wired/wireless local area network (LAN), wide area network (WAN), Ethernet, IEEE 1394, Bluetooth, AP-based Wi-Fi (wireless LAN network), Zigbee, high-definition multimedia interface (HDMI), universal serial bus (USB), mobile high-definition link (MHL), audio engineering society/European broadcasting union (AES/EBU), optical, and coaxial. The communication interface 110 may also be referred to as a communication unit or a communication module.

The memory 120 is configured to store various programs, data, instructions, etc. required for the operation of the electronic device 100. The memory may be implemented as at least one of various memories, such as dynamic RAM, static RAM (SRAM), synchronous dynamic RAM (SDRAM), one-time programmable ROM (OTPROM), programmable ROM (PROM), erasable and programmable ROM (EPROM), electrically erasable and programmable ROM (EEPROM), mask ROM, flash ROM, flash memory, a hard drive, or a solid state drive (SSD).

The memory 120 may store a client application for operation in conjunction with the encrypted LLM. Furthermore, depending on the type of services to be provided, a customized preprocessing module may be stored in memory 120. Specifically, a customized tokenizer, an embedding module, and the like may be stored. Furthermore, the memory 120 may store a set of tokens corresponding to the service type. This token set may be referred to as dictionary data. The token set may be updated from time to time or periodically.

The processor 130 is a component for controlling a general operation of the electronic apparatus 100. The processor 130 may perform various operations based on commands, programs, data, etc., stored in the memory 120.

The processor 130 may be implemented by a digital signal processor (DSP) or a microprocessor that processes a digital signal. However, the processor 130 is not limited thereto, but may include one or more of a central processing unit (CPU), a micro controller unit (MCU), a micro processing unit (MPU), a controller, an application processor (AP), a communication processor (CP), and an ARM processor, or an artificial intelligence (AI) processor, or may be defined by these terms. In addition, the processor may be implemented by a system-on-chip (SoC) or a large scale integration (LSI) in which a processing algorithm is embedded, or may be implemented in the form of a field programmable gate array (FPGA). The processor 130 may perform various functions by executing computer executable instructions stored in the memory 120.

In FIG. 2, the communication interface 110, the memory 120, and the processor 130 are each illustrated as one, but the number of these elements may vary.

According to various embodiments of the present disclosure, the processor may transmit the homomorphic ciphertext obtained by homomorphically encrypting the target information or the query. The target information or the query may be collectively referred to as an “item.” The query may be transmitted to the server apparatus by the processor 130 in the form of homomorphically encrypted homomorphic ciphertext or in plaintext. When the query is also provided in the form of the homomorphic ciphertext, for the purpose of distinction, the homomorphic ciphertext corresponding to the target information may be referred to as a first homomorphic ciphertext, and the homomorphic ciphertext corresponding to the query may be referred to as a second homomorphic ciphertext.

The homomorphic ciphertext may be generated by encrypting a plaintext message using a public or secret key. When decrypted using the secret key, the homomorphic ciphertext may be generated in the form that satisfies the following properties.

$$Dec ( ct , sk ) = 〈 ct , sk 〉 = M + e ( mod q ) \qquad 〈 Equation 1 〉$$

Here, <, > denotes a usual inner product, ct denotes a ciphertext, sk denotes the secret key, M denotes a plaintext message, e denotes an encryption error value, and mod q denotes a modulus of the ciphertext. q should be selected to be greater than a result value obtained by multiplying a scaling factor Δ by a message. When an absolute value of the error value e is sufficiently small compared to M, a decryption value M+e of the ciphertext is a value that may replace the original message with the same precision in significant figure operation. Among the decrypted data, an error may be arranged on the least significant bit (LSB) side, and M may be arranged on the next least significant bit side.

To perform the homomorphic encryption, the public key and the secret key are required. The processor 130 may generate and use the public key required to perform encryption by itself, or may receive and use the public key from an external device. For example, another terminal device performing decryption may generate the public key and the secret key, respectively, and then distribute the public key to other devices.

A method for generating the public key and the secret key may be implemented variously. For example, the processor 130 may generate the public key using a Ring-LWE technique. Specifically, the processor 130 may first set various parameters and rings and store them in the memory 120. Examples of the parameters may include lengths of plaintext message bits, sizes of public and secret keys, and the like.

The ring may be represented by the following equation.

$$R = {ℤ}_{q} [ x ] / ( f ( x ) ) \qquad 〈 Equation 2 〉$$

Here, R denotes a ring, Zq denotes a coefficient, and f(x) denotes an n-th polynomial.

The ring is a set of polynomials having predetermined coefficients, and means a set in which addition and multiplication are defined between elements and which is closed for addition and multiplication.

For example, the ring means a set of n-th polynomials having a coefficient Zq. Specifically, when n is Φ(N), it means an N-th cyclotomic polynomial. f(x) denotes ideal of Zq[x] generated by the f(x). The Euler totient function Φ(N) means the number of natural numbers that is coprime to N and smaller than N. When Φ_{N}(x) is defined as an N-th cyclotomic polynomial, the ring may also be represented by Equation 3 as follows.

$$R = {ℤ}_{q} [ x ] / ( {Φ}_{N} ( x ) ) \qquad 〈 Equation 3 〉$$

The ring of the above-described Equation 3 may have complex numbers in the plaintext space. Meanwhile, in order to improve the operation speed of the homomorphic ciphertext, only a set in which the plain text space is a real number in the above-described set of rings may be used.

When such a ring is established, the processor 130 may calculate the secret key sk from the ring.

The secret key sk may be represented as follows.

$$sk ← ( 1 , s ( x ) ) , s ( x ) ∈ R \qquad 〈 Equation 4 〉$$

Here, s(x) means a polynomial generated randomly with small coefficients.

The processor 130 may calculate a first random polynomial a(x) from the ring. The first random polynomial may be represented as follows.

$$a ( x ) ← R \qquad 〈 Equation 5 〉$$

Also, the processor 130 may calculate an error. Specifically, the processor may extract an error from a discrete Gaussian distribution or a distribution statistically close to the discrete Gaussian distribution. This error may be represented as follows.

$$e ( x ) ← {𝒟}_{α q}^{n} \qquad 〈 Equation 6 〉$$

When an error is calculated, the processor 130 may calculate a second random polynomial by performing modular operation on the error in the first random polynomial and the secret key. The second random polynomial may be represented as follows.

$$b ( x ) = - a ( x ) s ( x ) + e ( x ) ( mod q ) \qquad 〈 Equation 7 〉$$

Finally, a public key pk is set as follows in a form including the first random polynomial and the second random polynomial.

$$pk = ( b ( x ) , a ( x ) ) \qquad 〈 Equation 8 〉$$

Since the above-described key generation method is only an example, it is not necessarily limited thereto, and it goes without saying that the public key and the private key may be generated by other methods.

The processor 130 stores the generated public and secret keys in the memory 120. Since these keys are used for the homomorphic encryption, they may be collectively referred to as homomorphic encryption keys. In addition to the public and secret keys described above, the homomorphic encryption keys may also include an operation key used when performing the operation in the homomorphic ciphertext state. The operation key may include a rotation key, a multiplication key, an addition key, etc. Various embodiments of the present disclosure have been described based on a Cheon-Kim-Kim-Song (CKKS) scheme among the homomorphic encryption schemes. However, the homomorphic encryption scheme is not limited to this scheme, and various schemes such as Brakerski-Gentry-Vaikuntanathan (BGV), Brakerski-Fan-Vercauteren (BFV), Fully Homomorphic Encryption over the Torus (FHEW), and the Torus Fully Homomorphic Encryption (TFHE) scheme may be used.

The processor 130 may identify at least a portion of information input by the user or information previously stored in the memory 120 as the target information and homomorphically encrypt the target information using the public key to acquire a first homomorphic ciphertext. The processor 130 may transmit the first homomorphic ciphertext to the server apparatus 200 via the communication interface 110.

When the query for searching for information or identifiers stored in the server apparatus 200 is input, the processor 130 may transmit the query itself to the server apparatus 200 via the communication interface 110, and may homomorphically encrypt the query using the public key to acquire the second homomorphic ciphertext, and then transmit the second homomorphic ciphertext to the server apparatus 200.

Thereafter, when the operation result between the target information previously stored in the server apparatus 200 and the query is received via the communication interface 110, the processor 130 decrypts the operation result using the secret key. Since the target information and the query are each homomorphically encrypted, the operation result also becomes the homomorphic ciphertext.

When the inner product operation is performed and the target information corresponding to the query matches the second identifier, the decrypted operation result will be in the form 01000000. The processor 130 may verify the presence or absence and location of a specific bit value (e.g., 1) in the data. If 1 is present, the processor 130 may identify that the target information to be searched is stored in the server apparatus 200. If is not present, the processor 130 may identify that the target information to be searched is not stored in the server apparatus 200. In this case, the processor 130 may display, through the display, an error message (not illustrated) indicating that no search results exist.

Meanwhile, according to the embodiment, there may be cases where the target information and the query do not completely match. For example, the operation result may include various values other than 0 and 1, such as 0.2, 0.1, 0.7, and −0.4. In this case, the processor 130 may identify the target information as being stored in the server apparatus 200 even when a value that is approximately equal to or greater than 1 exists, even if the value does not completely match 1.

Meanwhile, when the server apparatus 200 stores a large amount of the target information, the process of querying and operating the entire the target information may take considerable time and increase the operation burden.

Accordingly, according to at least one embodiment of the present disclosure, the electronic apparatus 100 transmits the indexing information together to limit the search range. The server apparatus 200 may classify and store the target information according to the indexing information corresponding to the target information. When the query is received, the server apparatus 200 may specify a search space i.e., an indexing range within the entire storage space based on the indexing information corresponding to the query, and then perform the operation between the target information within the indexing range and the query.

The target information and the query may be configured as a vector. For example, when the target information, such as text or images, is input, the processor 130 may generate the target information as the vector using a search engine, a preset algorithm, a pre-trained AI model, etc. The processor 130 may homomorphically encrypt the generated vector using the public key or the secret key. The query may also be configured as the vector and homomorphically encrypted in a similar manner. In the present disclosure, “the target information” does not simply refer to the input the target information itself, but may also be interpreted to include the target information converted into the vector. Furthermore, the “query” may be interpreted to include not only the input query but also the query converted into the vector.

Alternatively, the target information and the query may each be configured as hash values.

Specifically, the processor 130 applies a preset hash function to the target information to convert the target information into the hash value. In this disclosure, the hash value corresponding to the target information is referred to as a first hash value. The processor 130 may generate the first hash value using a SHA-2 (SHA-224, SHA-256, SHA-384, SHA-512) hash algorithm, but the type of hash algorithms is not limited thereto.

When the SHA-256 algorithm is used, the processor 130 may generate the first hash value in the following manner:

$$H = SHA 256 ( v ) [ 0 : 128 ] XOR SHA 256 ( v ) [ 129 : 256 ] , \qquad 〈 Equation 9 〉$$

$$sqrt ( 64 ) = {2}^{3}$$

Referring to Equation 9, the processor 130 divides SHA256 (v) consisting of a total of 256 bits into 128-bit parts, and then performs an XOR operation on them to ultimately generate a first hash value of 128 bits. In Equation 9, v may be the target information. The processor 130 may not homomorphically encrypt the target information as it is, but may convert the target information into the homomorphic ciphertext after normalizing the target information to a certain size. When converting the first hash value into the hash value, the processor 130 may normalize the first hash value into a vector of a preset length and homomorphically encrypt the normalized vector using the above-described public key to generate the first homomorphic ciphertext. For example, the processor 130 may normalize the data into the vector of length l and then perform the homomorphic encryption using the CKKS algorithm. However, the normalization is not necessarily required and may be omitted depending on the embodiment. Furthermore, even if the normalization is performed, the order, normalization length, and encryption algorithm are not limited thereto and may be configured in various ways.

The processor 130 may also generate the indexing information separately from generating the first homomorphic ciphertext. The indexing information is information for indexing a storage space where the target information is stored by classifying the target information into a plurality of groups. Based on the indexing information, the processor 130 may identify a range for searching information, i.e., an indexing range. The indexing range may also be referred to as a storage space. For convenience of description, the indexing information generated in relation to the target information is referred to as first indexing information, and the indexing information generated in relation to the query is referred to as second indexing information. The indexing information may be generated in various forms. This will be further described in detail in the following section.

The processor 130 generates the first homomorphic ciphertext and the first indexing information corresponding to the target information, respectively, and then transmits the generated first homomorphic ciphertext and first indexing information to the server apparatus 200 via the communication interface 110.

Thereafter, when the query is input the processor 130 may apply one of various methods, such as an AI model, a search engine algorithm, or a hash function, to the query to acquire the vector value and the second indexing information corresponding to the query, respectively.

Among those, when the hash function is used, the processor 130 transmits the query vector, which is the result value of applying the hash function to the query, and transmits the second indexing information to the server apparatus 200 via the communication interface 110.

While the method applied to the target information and the query for similarity search may be the same, it is not necessarily limited to this method, and different methods may be applied. For example, when using the hash function, the first hash function may be applied to the target information and the query, converting them into vectors. The second hash function may then be applied to the target information and the query, thereby generating the first and second the indexing information, respectively.

Also, the normalization process may be performed on the second hash value, normalizing into a vector of a preset length. However, like the target information, this process is not necessarily performed and may be omitted.

Additionally, as described above, the electronic apparatus 100 may directly generate and store classification criteria or transmit them to the server apparatus 200. The classification criteria are data that may be used as criteria for classifying information stored in the server apparatus 200 into a plurality of groups, i.e., an indexing range.

In an embodiment where the electronic apparatus 100 directly generates and transmits classification criteria to the server apparatus 200, the processor 130 may also encrypt the classification criteria and transmit them to the server apparatus 200.

Meanwhile, as described above, the classification criteria may also be generated by the server apparatus 200 and transmitted to the electronic apparatus 100. In this case, the processor 130 may store the classification criteria in the memory 120.

Accordingly, when the server apparatus 200 has information to store, the processor 130 may identify the indexing range for the information based on classification criteria, generate first the indexing information to indicate the identified indexing range, and transmit the first the indexing information to the server apparatus 200 along with the target information. Thereafter, when the query for information retrieval is input, the processor 130 may identify the indexing range corresponding to the query based on the classification criteria, generate second the indexing information to indicate the indexing range, and transmit the second the indexing information to the server apparatus 200 along with the query.

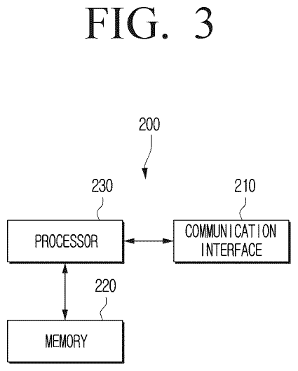

FIG. 3 is a block diagram illustrating a configuration of the server device according to at least one embodiment of the present disclosure. Referring to FIG. 3, the server device 200 includes a communication interface 210, a memory 220, and a processor 230. Specific examples of each of the communication interface 210, the memory 220, and the processor 230 are identical to those described in FIG. 2, and therefore, a detailed description thereof will be omitted.

The server apparatus 200 may be implemented as a web server, cloud server, or other device to provide various services. For example, the server apparatus 200 may be used in various fields where security is important, such as a medical management server that stores information on various patients, a management server that stores user-specific authorization information, a financial institution server, or an access control server.

The communication interface 210 of the server apparatus 200 may communicate with various external devices, as illustrated in FIG. 1. For example, the communication interface 210 may communicate with the electronic apparatus 100 of FIG. 2.

The memory 220 may store various programs, instructions, and data for operating the server apparatus 200. For example, the memory 220 may store plurality of pieces of the target information and identifiers. As described above, the target information may include various types of information. The identifiers may be generated sequentially or randomly for the target information. The identifiers may be composed of a combination of various texts, such as letters, numbers, and symbols. While the target information is stored in a homomorphically encrypted state, the identifier may be stored in the form of the plaintext data. Furthermore, according to the embodiment, the memory may also store a plurality of preset classification criteria.

When the query is received via the communication interface 210, the processor 230 may perform a preset operation between the query and the plurality of pieces of target information stored in the memory 220. For example, the processor 230 may perform the inner product operation. As described above, the query may be plaintext or the homomorphic ciphertext homomorphically encrypted using the public key, i.e., the second homomorphic ciphertext. The following description will focus on the case implemented as the second homomorphic ciphertext.

The processor 230 may acquire the final operation result that combines all inner product operation results and transmit the final operation result to an external device via the communication interface 210. The external device may be the electronic apparatus that generates the homomorphic ciphertext, or may be a device other than the electronic apparatus 100. The operation result may be the PMT result data described above, but is not necessarily limited thereto. It may also be private information retrieval (PIR) result data or private set intersection (PSI) result data. The PIR result data may be the homomorphic ciphertext that includes the target information corresponding to the query among the target information, and the PSI result data may be the homomorphic ciphertext that includes data corresponding to the intersection between the plurality of pieces of target information and the query. Hereinafter, the following description will be based on the case where the operation result is used as the PMT result data.

When the processor 230 receives the information on the order of information corresponding to the query within the transmitted operation result from the electronic apparatus 100 via the communication interface 210, the processor 230 reads the identifier corresponding to the order from the memory 220 and transmits the identifier to the electronic apparatus via the communication interface 210.

Meanwhile, when the number of pieces of target information items is too large, it may take a long time to match each identifier with its corresponding target information and store the identifier.

According to at least one embodiment of the present disclosure, the processor 230 may limit the indexing range based on the classification criteria and then search for information within the limited indexing range. Specifically, the processor 230 may pre-generate a matching table that matches the order or location in which each piece of the entire target information is stored with a plurality of identifiers assigned to each piece of target information, and store the matching table in the memory 220.

As described above, each electronic apparatus 100 may transmit the first indexing information along with the target information. Based on the first indexing information, the processor 230 may determine the indexing range corresponding to the target information and include the information on the indexing range in the matching table. That is, the processor 230 may use the first indexing information generated for the target information to classify and store the order of the target information within the matching table.

Subsequently, when the query and the second indexing information are received, the processor 230 may identify the indexing range using the second indexing information, identify the locations of the target information within the indexing range based on the matching table, and then perform the inner product operation on the target information at the identified locations and the query.

Subsequently, when the order information is received from the electronic apparatus 100, the processor 230 may identify the identifier corresponding to the order information based on the matching table.

The indexing range may be determined in various ways. For example, the indexing range may be determined by upper k bits of the hash value. If k is 8, the indexing range may be divided into 28=256. That is, the processor 230 may divide the entire target information into a total of 256 buckets and store them in the memory 220. Each bucket includes approximately 39,000 entries. When the processor 230 receives the second homomorphic ciphertext, i.e., the query, it only needs to search the buckets within the corresponding indexing range, significantly improving search speed compared to searching the entire target information.

The indexing method may be designed so that similar data is stored in the same indexing range. As another example, the indexing method may also be designed and used with a separate hash function, such as LSH.

The first indexing information and the second indexing information may be configured in various forms, including a hash value, an inner product operation result for plurality of Gaussian vectors, a counting result of counting the number of elements with a size greater than a threshold, random point information, or a sign bit.

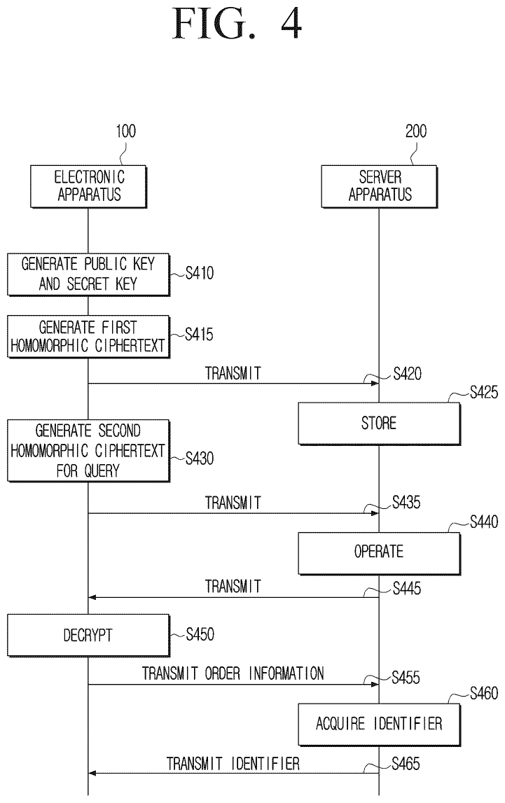

FIG. 4 is a timing diagram for describing operations of the electronic apparatus and the server apparatus according to at least one embodiment of the present disclosure.

Referring to FIG. 4, the electronic apparatus 100 generates and stores the public key and the secret key, respectively (S410). In addition to the public key and the secret key, the operation key may also be generated. The electronic apparatus 100 may share the public key and the operation key with the server apparatus 200 or other external devices.

In this state, when the target information is specified or input by the user, the electronic apparatus generates the first homomorphic ciphertext corresponding to the target information (S415). The target information may be vector data. For example, the electronic apparatus may apply the preset hash function to the target information, convert it into a hash value, and then homomorphically encrypt it using the public key. However, this is not necessarily limited thereto. The target information may also be homomorphically encrypted directly using the public key or the secret key. Alternatively, a normalization step may be added to normalize the target information or its hash value before performing the homomorphic encryption.

The electronic apparatus 100 transmits the first homomorphic ciphertext to the server apparatus 200 (S420). In this case, the electronic apparatus 100 may also transmit the first indexing information for the first homomorphic ciphertext.

The server apparatus 200 stores the first homomorphic ciphertext received from the electronic apparatus 100 (S425). When the first indexing information is transmitted together, the server apparatus 200 may determine the storage location of the first homomorphic ciphertext based on the first indexing information.

The server apparatus 200 may also receive and store the homomorphic ciphertext for the target information received from electronic apparatuses other than the electronic apparatus 100. When the first homomorphic ciphertext is received, the server apparatus 200 may automatically generate the corresponding identifier, match the identifier with the first homomorphic ciphertext, and store the identifier and first homomorphic ciphertext together. Furthermore, the server apparatus 200 may also generate or update the matching table described above.

In this state, a user may wish to confirm whether their desired target information is stored in the server apparatus 200. In this case, the user may input the query through the electronic apparatus 100.

When the query is input, the electronic apparatus 100 generates the second homomorphic ciphertext corresponding to the query (S430). However, this is not necessarily limited thereto, and if the query is used in the form of the plaintext, the step of encrypting the query with the second homomorphic ciphertext may be omitted.

The query may also be provided in the form of the hash value. Specifically, the electronic apparatus 100 may apply the preset hash function to the query, convert the query into the hash value, and then homomorphically encrypt the hash value using the public key to acquire the second homomorphic ciphertext. However, this is not necessarily limited thereto, and the query may also be homomorphically encrypted directly using the public key. As described above, the normalization process may also be added to the query.

The electronic apparatus 100 transmits the second homomorphic ciphertext to the server apparatus 200 (S435). When receiving the second homomorphic ciphertext, the server apparatus 200 sequentially operates the second homomorphic ciphertext with the previously stored homomorphically encrypted target information (S440).

When the second indexing information is provided, the server apparatus may determine the indexing range among the entire stored information based on the second indexing information, and may perform operations with the second homomorphic ciphertext only for the target information within the determined indexing range.

Each indexing range may be identified based on the pre-stored matching table. Specifically, the operation may be the inner product operation.

The server apparatus 200 transmits the operation result to the electronic apparatus 100 (S445).

The electronic apparatus 100 decrypts the operation result using the secret key (S450). The decrypted data includes the inner product operation result between the sequentially arranged target information and the query. The inner product operation result for the target information identical to the query becomes 1, and the inner product operation result for other the target information becomes 0. Therefore, the electronic apparatus 100 may identify whether the target information corresponding to the query exists in the decrypted data. In addition, the electronic apparatus 100 may also identify the order of the target information.

When the target information does not completely match the query, the inner product operation result may not completely be displayed as 1, but may be calculated as a value close to 1. The electronic apparatus 100 may identify the value most closely matching the query among the decrypted values as the order information.

The electronic apparatus 100 transmits the identified order information to the server apparatus 200 (S455). The server apparatus 200 obtains an identifier corresponding to the order information (S460) and then transmits the identifier to the electronic apparatus 100 (S465).

Therefore, the electronic apparatus 100 may acquire the identifier corresponding to the desired target information. Using the identifier, the electronic apparatus 100 may request the server apparatus 200 to transmit the target information or request that the target information be transmitted to another device in the homomorphically encrypted state. Therefore, the target information may be utilized in various ways while maintaining security.

When a large amount of the target information provided by the plurality of electronic apparatuses is stored in the server apparatus 200, the server apparatus 200 may consume significant time and resources to perform the inner product operation on all the target information and queries.

Accordingly, according to another embodiment of the present disclosure, the electronic apparatus 100 may also search for the target information using the indexing information.

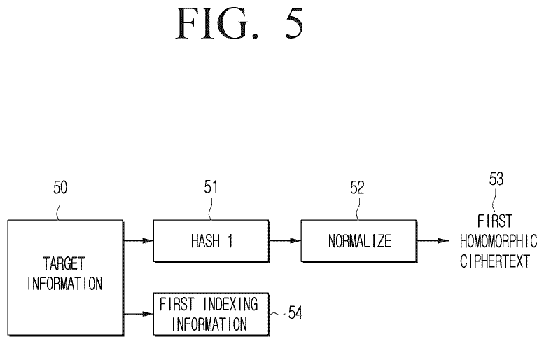

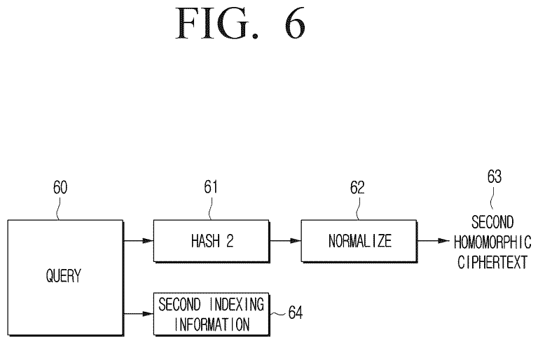

FIGS. 5 and 6 are diagrams for describing a process of generating the indexing information from the target information and the query, respectively.

Referring to FIG. 5, the electronic apparatus 100 generates a first hash value 51 and first indexing information 54 corresponding to the target information 50 in parallel. The electronic apparatus 100 normalizes (52) the first hash value 51 into a vector of a preset length and homomorphically encrypts the normalized vector to generate a first homomorphic ciphertext 53. The first indexing information 54 is information for determining the indexing range of the target information.

Referring to FIG. 6, the electronic apparatus 100 generates a second hash value 61 and second indexing information 64 corresponding to a query 60 in parallel. The electronic apparatus 100 normalizes the second hash value 61 into a vector of a preset length 62 and homomorphically encrypts the normalized vector to generate a second homomorphic ciphertext 63. The second indexing information 64 is information for determining a space to search using the query.

For example, the first and the second indexing information may be implemented as k-bit hash values. That is, the electronic apparatus 100 may generate the first hash value 51 for the target information while applying a separately preset hash function, thereby generating another hash value. In addition, the electronic apparatus 100 may generate the second hash value 61 for the query while applying a separately preset hash function, thereby generating another hash value. The hash function used to generate the indexing information may be the same as the hash function used to generate the first and second hash values, but is not necessarily limited thereto.

Additionally, the indexing information may be generated using various types of information. While FIGS. 5 and 6 illustrate performing normalization operations 52 and 62, the normalization operation may be omitted according to the embodiment.

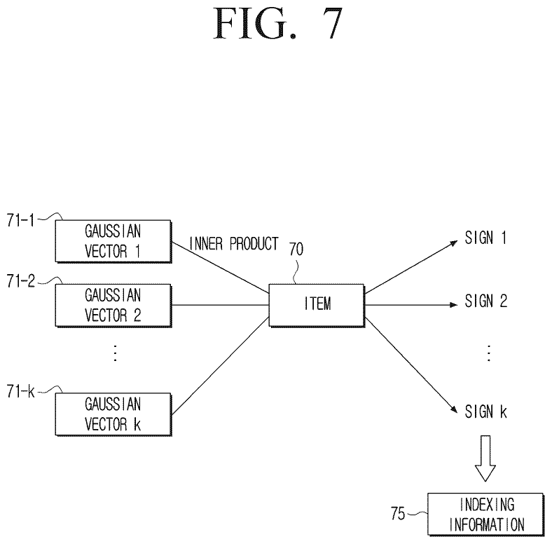

FIG. 7 is a diagram illustrating a method for generating indexing information using a plurality of Gaussian vectors.

Referring to FIG. 7, the processor 130 randomly generates a plurality of Gaussian vectors 71-1 to 71-k. When the target information or the query is referred to as an item 70, the processor 130 performs the inner product operation on the plurality of generated Gaussian vectors and the item, respectively, to acquire a plurality of sign values sign 1 to sign k and combine the sign values to generate indexing information 75. Depending on the content of the item 70, the indexing information 75 becomes either the first indexing information or the second indexing information.

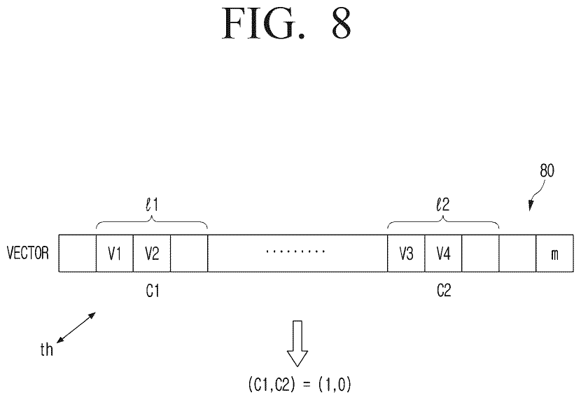

FIG. 8 is a diagram for describing a method for generating indexing information using a threshold. Referring to FIG. 8, the processor 130 of the electronic apparatus 100 pre-generates a threshold th and stores the threshold th in the memory 120.

The processor 130 compares a plurality of preset elements among each element of a vector 80 corresponding to the target information and the query with the preset threshold, and generates the first or the second indexing information including a counting result of counting the number of elements having a size greater than or equal to the threshold.

Referring to FIG. 8, elements l1 (v1 and v2) and l2 (v3 and v4) of a preset length l are sampled from among the respective elements of the vector 80 and then compared with the threshold th. If th is 0.5, v1 and v2 are 0.1 and 0.7, respectively, and v3 and v4 are 0.2 and 0.3, respectively, then there is one element greater than th within l1, but there is no element in l2. Accordingly, counting results c1 and c2 of counting the number of elements exceeding the threshold within l1 and l2 becomes (1, 0). The first and the second indexing information may be implemented in the form that includes these counting results.

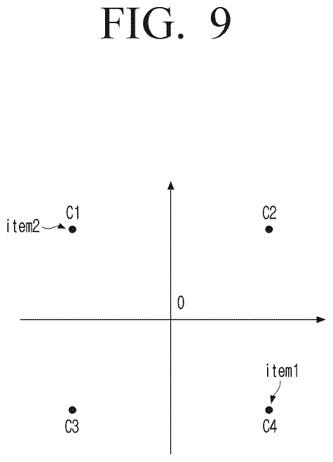

FIG. 9 is a diagram illustrating a method for generating indexing information corresponding to each piece of information using a coordinate system.

The processor 130 may generate a plurality of points C1, C2, C3, and C4 located in each area on an n-dimensional Euclidean space coordinate system. When the target information is identified, the processor 130 may generate the first indexing information based on the point C1 (FIG. 9) with the closest linear distance to the data point (item 1) corresponding to the target information. The points may be generated randomly or assigned a specific value.

When the query (item 2) is identified, the processor 130 may generate the second indexing information based on the point C4 (FIG. 9) with the closest linear distance to the data point (item 2) corresponding to the query.

According to the embodiment, the processor 130 may select the point with the highest cosine similarity other than the closest linear distance, and the similarity criteria are not limited thereto.

In addition, the electronic apparatus may also generate the indexing information based on the sign of each element of the vector corresponding to the item. Specifically, the processor 130 selects k dimensions within the vector data corresponding to the item and extracts a sign bit from the selected dimensions. For example, if values greater than 0 are converted into 1 and values less than or equal to 0 are converted into 0, then the data vector is (0.8, −1.2, 3.5, 0.0, −0.7), and if the selected dimensions are 1, 2, and 4, then the sign bit becomes (1, 0, 0). In this manner, the processor 130 may generate the first indexing information including a plurality of bits with different bit values depending on the sign of each element of the vector corresponding to the target information. The processor 130 may also generate the second indexing information including plurality of bits with different bit values depending on the sign of each element of the vector corresponding to the query. In this case, the processor 130 may select dimensions in a normal distribution form so that the sign bits may be as random as possible.

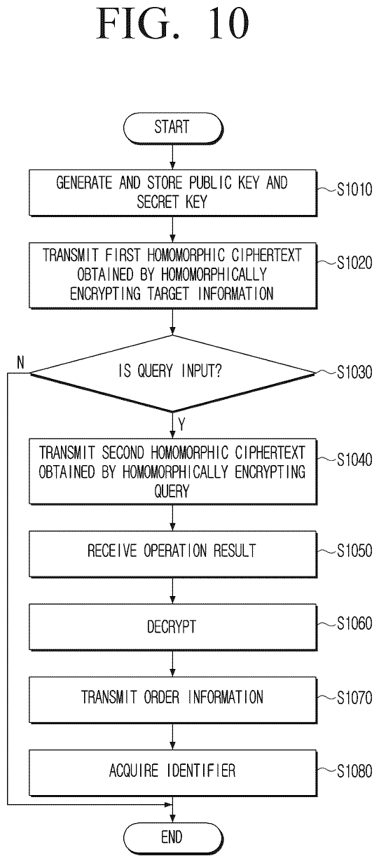

FIG. 10 is a flowchart for describing a data processing method of an electronic device according to at least one embodiment of the present disclosure.

Referring to FIG. 10, the electronic apparatus 100 generates and stores the public key and the secret key (S1010). The method for generating a public key and a secret key may vary depending on the encryption mechanism. Since a detailed description thereof has been described above, a duplicate description will be omitted.

When the target information to be stored in the server apparatus is determined, the electronic apparatus generates the first homomorphic ciphertext by homomorphically encrypting the target information and transmits the first homomorphic ciphertext to the server apparatus (S1020). In this case, the target information may be converted into the hash value, normalized, and then homomorphically encrypted. Furthermore, the first indexing information may be generated for the target information. The method for generating the first indexing information has been described in detail in the above section, so a detailed description will be omitted.

When the query is entered in this state (S1030), the electronic apparatus generates the second homomorphic ciphertext by homomorphically encrypting the input query, and then transmits the second homomorphic ciphertext to the server apparatus (S1040). The query may also be homomorphically encrypted after being converted into the vector by applying the hash function, and the second indexing information for the query may also be generated as described above. Furthermore, in embodiments where the query is provided in the form of the plaintext, the step of generating the second homomorphic ciphertext may be omitted.

Thereafter, when receiving the operation result from the server apparatus (S1050), the electronic apparatus decrypts the operation result using the secret key (S1060). Based on the result value, the electronic apparatus may identify whether the target information it was searching for is stored on the server apparatus.

As described above, when the second indexing information is also transmitted, the operation result may be received between the pieces of information within the indexing range corresponding to the second indexing information among all information stored on the server apparatus and the query. This minimizes the time and resources required for the search.

When the electronic apparatus identifies that the target information is stored on the server apparatus, the electronic apparatus identifies the order information for the target information based on the operation result and transmits the order information to the server apparatus (S1070).

When the identifier corresponding to the order information is transmitted from the server apparatus, the electronic apparatus may acquire the identifier (S1080).

The data processing method described in FIG. 10 may be performed by the electronic apparatus 100 illustrated in FIG. 2, but is not limited thereto. It may also be performed by electronic apparatuses having various configurations.

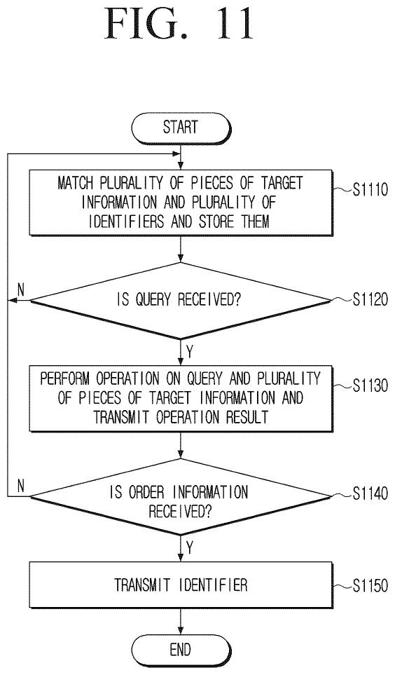

FIG. 11 is a flowchart for describing a data processing method of a server apparatus according to at least one embodiment of the present disclosure.

According to FIG. 11, the server apparatus matches the plurality of pieces of target information and the plurality of identifiers and stores them (S1110). The target information is the homomorphic ciphertext received from various external devices in the homomorphically encrypted state.

In this state, when the query is received from one electronic apparatus (S1120), the server apparatus performs an operation on the received query and the plurality of pieces of stored target information and transmits the operation result to the electronic apparatus (S1130). The query may be in the form of the plaintext or homomorphic ciphertext.

According to the embodiment, the server apparatus may also receive the first indexing information for the target information and the second indexing information for the query. The first and the second indexing information may be provided to the server apparatus in the unencrypted state. Based on the first and the second indexing information, the server apparatus limits the indexing range to be searched within the entire storage space and may perform an operation with the query only on the target information within the limited indexing range.

Thereafter, when the order information is received from the electronic apparatus (S1140), the server apparatus transmits the identifier corresponding to the order information to the electronic apparatus (S1150).

The data processing method of FIG. 11 may be performed by the server apparatus 200 illustrated in FIG. 3, but is not necessarily limited thereto and may be performed by the server apparatus having various configurations.

According to the above-described embodiments, the search space may be reduced by utilizing the indexing range. However, when new data continues to be added to the server apparatus and thus the amount of stored information increases, the existing identifiers may become inefficient and may be reconfigured. In this case, the server apparatus should retransmit all stored information to the electronic apparatus, decrypt and re-encrypt the information on each electronic apparatus, and then retransmit the re-encrypted information to the server apparatus. The server apparatus must then assign a new identifier to the information and store the identifier. This re-indexing consumes significant network traffic, time, and costs, and may also pose security vulnerabilities.

Accordingly, according to another embodiment of the present disclosure, a novel indexing method that improves the search speed of a large-scale vector database while minimizing unnecessary resource consumption for re-indexing is disclosed.

Specifically, the processor 130 of the electronic apparatus 100 may determine the entire index hierarchy to be used by the server apparatus 200 and the location within that hierarchy where the corresponding target information will be stored, thereby generating the first indexing information including the index path information for specifying the indexing range.

That is, when the server apparatus 200 stores a certain amount of target information or less, the server apparatus may also perform an operation between the query and the entire target information without necessarily distinguishing the indexing range, thereby providing the operation result. However, as the amount of the target information stored increases, it is more efficient to distinguish the indexing range as described above and perform queries and operations on only some of the information. Accordingly, the server apparatus 200 may sequentially determine the indexing range based on the accumulated storage amount of target information.

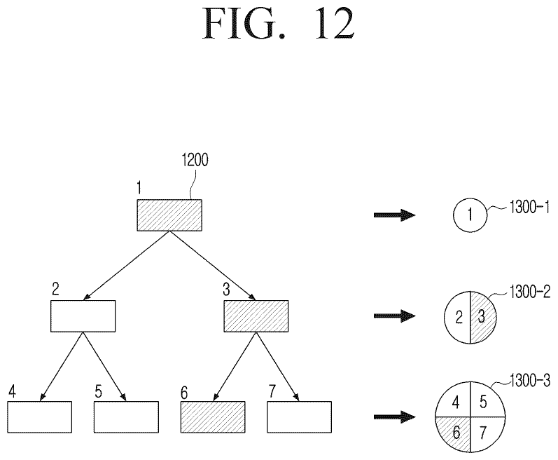

FIG. 12 is a diagram for describing the entire indexing hierarchy and a method for specifying an indexing range within the hierarchy.

In FIG. 12, the left diagram illustrates the storage volume of the target information stored in the server apparatus in a bar graph format, while the right diagram illustrates it in a circular graph format.

Specifically, since the amount of data stored in the server apparatus 200 is small in the initial stage, all information is included within a single indexing range (1). Thereafter, when the target information exceeding the preset amount or number (e.g., 1,000) is stored, the server apparatus 200 divides the indexing range into two (2, 3). The number of stored information within each indexing range need not be identical and may be set to various values. Thereafter, as the number of information further increases, the server apparatus 200 further divides the indexing range into four (4, 5, 6, and 7) again. The above-described indexing range may be referred to as the entire index hierarchy in the present disclosure. When displayed in the circular graph format, the size of the circle may represent the total amount of information. Accordingly, as the stored information increases, diameters of circular graphs 1300-1, 1300-2, and 1300-3 may gradually increase. A top layer of the index hierarchy in FIG. 12 may be referred to as a root 1, a second layer as clusters 2 and 3, and a third layer as sub-clusters 4, 5, 6, and 7. While FIG. 12 illustrates three layers, additional layers may be added based on the number of information within each indexing range and the total number of information. For example, a fourth layer may be comprised of a total of eight sub-clusters, such as 8 to 15.

The processor 130 of the electronic apparatus 100 may pre-calculate an index path for the index range where the target information will be stored, based on a predefined hierarchical index structure between the electronic apparatus 100 and the server apparatus 200. For example, initially, all the information is included in cluster 1 and is therefore identical. However, when the amount of information increases and the indexing range needs to be divided into three layers, it may be designed to be included in cluster 3. If the indexing range needs to be divided into three layers again, it may be included in cluster 6.

The server apparatus 200 may store the information on the plurality of predefined classification criteria. The classification criteria may be configured to be set in various forms, such as Gaussian vectors. The classification criteria may be a centroid selected from the plurality of pieces of target information. Alternatively, the classification criteria may be determined through learning based on the target information. When the indexing information is generated using the hash, the classification criteria may be the hash function itself. When the indexing information is generated using a sign count, the classification criteria may be determined by how the sign and count are extracted.

As described above, the apparatus for generating the classification criteria and the apparatus for storing the classification criteria may each be implemented in various ways according to the embodiment.

For example, the classification criteria may be stored in the server apparatus 200 in the unencrypted state. In this state, when the electronic apparatus 100 transmits the query, the processor 230 of the server apparatus 200 performs an operation between the classification criteria information that distinguishes each cluster (i.e., indexing range) and the query to identify the classification criteria that is most similar to the query. When the most similar classification criteria is identified, the processor 230 of the server apparatus 200 may operate the query with the information within at least one indexing range corresponding to the classification criteria and provide the operation result to the electronic apparatus 100.

As another example, the classification criteria information may be stored in the server apparatus 200 in the encrypted state. In this case, even if the server apparatus computes the classification criteria information and the query, the server apparatus may not be able to determine whether the classification criteria information and the query are similar. Accordingly, the server apparatus 200 may transmit the plurality of pieces of classification criteria information to the electronic apparatus 100 in advance, and the electronic apparatus 100 may decrypt and verify the information using the secret key. The electronic apparatus 100 may identify the classification criteria most similar to the query among the decrypted classification criteria and then generate the second indexing information corresponding to the classification criteria.

The determination of similarity between the query and the classification criteria may vary depending on the classification criteria. For example, when using the Gaussian vector or centroid as the classification criteria, the query and the plurality of classification criteria may each be subjected to the inner product operation, and then the identity or similarity may be determined based on the inner product result. Specifically, the processor 130 of the electronic apparatus 100 may determine that the target information is identical or highly similar when the inner product operation result is 1, and may determine that the target information is dissimilar when the result is 0.

In the example of FIG. 12, when the data is divided into seven indexing ranges 1 to 7, the server apparatus 200 transmits the stored classification criteria information to the electronic apparatus 100. The server apparatus 200 may transmit the plurality of classification criteria information to the electronic apparatus 100 in advance, regardless of whether the query is received, or may transmit the information when the query is received.

After receiving the plurality of classification criteria information, the processor 130 of the electronic apparatus 100 decrypts the received classification criteria using the secret key when the plurality of classification criteria are encrypted. The processor 130 may identify the classification criteria most closely matching the query among the classification criteria. The processor 130 generates the second indexing information including the identified classification criteria information and transmits the second indexing information to the server apparatus 200 along with the query. The processor 230 of the server apparatus 200 may operate the query with information within the indexing range corresponding to the second indexing information and provide the operation result to the electronic apparatus 100.

In the case of FIG. 12, the second indexing information may be in the form of a list including hierarchical information, considering that classification is performed sequentially, rather than determining a single indexing range.

The above description assumes that the server apparatus 200 generates and stores the classification criteria. However, the classification criteria may also be generated by the electronic apparatus.

For example, the processor 130 of the electronic apparatus 100 may generate the plurality of classification criteria, encrypt the plurality of generated classification criteria, and transmit the plurality of generated classification criteria to the server apparatus 200. The server apparatus 200 may store the information on the plurality of transmitted classification criteria.

The electronic apparatus 100 transmits the first indexing information on the target information to the server apparatus 200, and the server apparatus 200 may determine the storage location or order of each the target information based on the plurality of classification criteria. When the query is entered in this state, the client may use the query to generate the second indexing information, as described in the above-described embodiment.

As another example, the classification criteria may be generated by the server apparatus 200 and then provided to the electronic apparatus 100. In this case, the electronic apparatus 100 may store the information on the classification criteria. When the target information to be stored and the query are entered, the electronic apparatus 100 may generate the first indexing information corresponding to the target information and the second indexing information corresponding to the query.

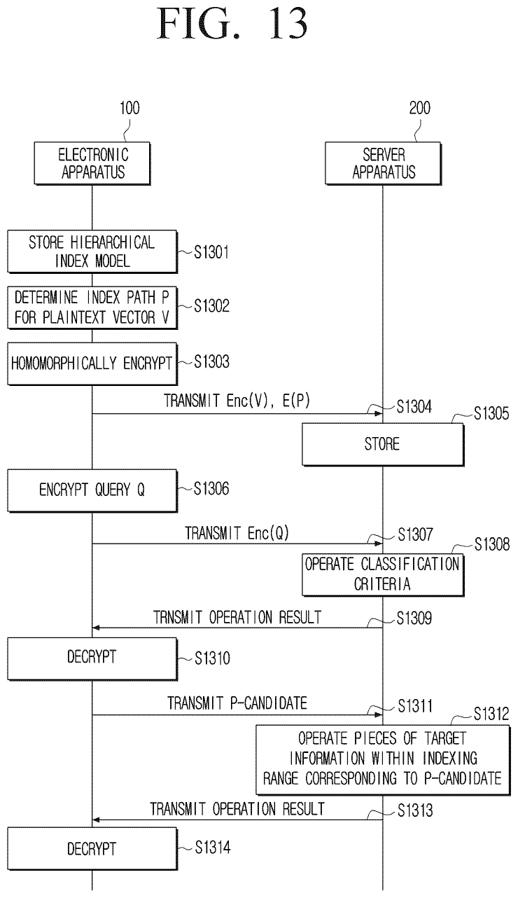

FIG. 13 is a timing diagram for describing the operations of the electronic apparatus 100 and the server apparatus 200 according to the embodiment of FIG. 12. Referring to FIG. 13, the electronic apparatus 100 may store a pre-trained hierarchical index model (S1301). The hierarchical index model refers to a model that narrows the search path by dividing the target information into the plurality of levels (i.e., hierarchies). Alternatively, it may be referred to as a tree structure or a multi-level clustering structure. The hierarchical index model may be, for example, a hierarchical K-means or locality sensitive hashing forest (LSH) model. The hierarchical K-means model is an algorithm that clusters data into K clusters and then hierarchizes the clusters, while the LSH Forest model is a model that searches for data by creating the plurality of hash trees.

When the electronic apparatus 100 has the target information to be stored in the server apparatus, it determines an index path P for the plaintext vector V corresponding to the target information based on the index model (S1302). According to the example of FIG. 12, the index path P may be (1, 3, 6), or if (1, 3) may be determined from 6, it becomes 6.

The electronic apparatus 100 converts the plaintext vector V into the first homomorphic ciphertext Enc (V) using the preset homomorphic encryption scheme and transmits the first homomorphic ciphertext Enc (V) together with the first indexing information (P) including an index path (S1303, S1304).

The server apparatus 200 may store the transmitted information (S1305).

Thereafter, when performing the data search, the electronic apparatus 100 homomorphically encrypts the query vector Q to be searched and transmits the homomorphic ciphertext Enc (Q) (S1306, S1307). As described above, in other embodiments, unencrypted plaintext Q may be transmitted. This is not illustrated here.

The server apparatus 200 operates the Enc (Q) with the plurality of previously stored classification criteria information and transmits the operation result to the electronic apparatus 100 (S1308, S1309).

The electronic apparatus 100 receives the operation result and then decodes the operation result (S1310). Accordingly, it identifies the classification criteria identical to or most similar to the query among all classification criteria, and then transmits the information about the indexing range P-candidate corresponding to that classification criteria to the server apparatus 200 (S1311).

The server apparatus 200 operates the Enc (Q) with the target information within the indexing range corresponding to the received information and transmits the operation result to the electronic apparatus 100 (S1312, S1313).

The electronic apparatus 100 may decrypt the operation result (S1314) to find the target information. Alternatively, when the identifiers of the target information are stored by classifying the identifiers according to the indexing range as described above, the electronic apparatus 100 may decrypt the operation result, extract the identifier corresponding to the target information, and then transmit the information on the identifier to the server apparatus 200 to receive the target information.

As described above, according to various embodiments of the present disclosure, rather than scanning all data stored on a server apparatus, the amount of homomorphic encryption computation may be dramatically reduced by first identifying highly relevant identifiers and then using those identifiers to search only a portion of the indexing range.

In particular, as illustrated in FIGS. 12 and 13, when the indexing information considering the hierarchical index structure is used, it is possible to easily cope with the case where data is added to the server apparatus 200 and the indexing range needs to be newly classified.

Various embodiments of the present disclosure have been described in detail above, each embodiment need not be implemented in isolation and may be implemented partially or fully in conjunction with other embodiments.

Meanwhile, methods according to at least some of the various embodiments of the present disclosure described above may be implemented in the form of applications that may be installed on existing electronic apparatuses. Additionally, the methods according to at least some of the various embodiments of the present disclosure described above may be implemented only with a software upgrade or a hardware upgrade for an existing electronic apparatus.

Meanwhile, according to an embodiment of the disclosure, various embodiments described above may be implemented by software including instructions stored in a machine-readable storage medium (for example, a computer-readable storage medium). A machine may be an apparatus that invokes the stored instruction from the storage medium and may be operated depending on the invoked instruction, and may include the electronic apparatus (for example, the electronic apparatus A) according to the disclosed embodiments. In the case in which a command is executed by the processor, the processor may directly perform a function corresponding to the command or other components may perform the function corresponding to the command under a control of the processor. The command may include codes created or executed by a compiler or an interpreter. The machine-readable storage medium may be provided in a form of a non-transitory-readable storage medium. Here, the ‘non-transitory-readable storage medium’ means that the storage medium is a tangible device, and does not include a signal (for example, electromagnetic waves), and the term does not distinguish between the case where data is stored semi-permanently on a storage medium and the case where data is temporarily stored thereon. For example, the “non-transitory-readable storage medium” may include a buffer in which data is temporarily stored.

According to an embodiment, the methods according to the diverse exemplary embodiments disclosed in the present document may be included and provided in a computer program product. The computer program product may be traded as a product between a seller and a purchaser. The computer program product may be distributed in the form of a machine-readable storage medium (for example, compact disc read only memory (CD-ROM)), or may be distributed (for example, download or upload) through an application store (for example, Play Store™) or may be directly distributed (for example, download or upload) between two user devices (for example, smartphones) online. In a case of the online distribution, at least some of the computer program products (for example, downloadable app) may be at least temporarily stored in a machine-readable storage medium such as a memory of a server of a manufacturer, a server of an application store, or a relay server or be temporarily created.

Although exemplary embodiments of the present disclosure have been illustrated and described hereinabove, the present disclosure is not limited to the abovementioned specific exemplary embodiments, but may be variously modified by those skilled in the art to which the present disclosure pertains without departing from the gist of the present disclosure as disclosed in the accompanying claims. These modifications should also be understood to fall within the scope and spirit of the present disclosure.

1. An electronic apparatus, comprising:
a communication interface;
a memory; and
a processor,
wherein the processor is configured to generate a public key and a secret key for homomorphic encryption, respectively, and store the public key and secret key in the memory,
transmit a homomorphic ciphertext obtained by encrypting target information using the public key or the secret key to the server apparatus via the communication interface,
transmit a query for searching for an identifier of the target information to the server apparatus via the communication interface, and
when an operation result obtained by operating the query with pieces of information within an indexing range identified based on a preset classification criterion among a plurality of pieces of information stored in the server apparatus is transmitted from the server apparatus, decrypt the operation result using the secret key, identify an order of the target information based on the decrypted operation result, and transmit information on the identified order to the server apparatus to acquire an identifier corresponding to the target information, and
the query is plaintext or a homomorphic ciphertext obtained by homomorphically encrypting the plaintext.

2. The electronic apparatus as claimed in claim 1, wherein the processor is configured to transmit first indexing information for the target information to the server apparatus along with the homomorphic ciphertext, and
transmit second indexing information for the query to the server apparatus along with the query, and
the indexing range is identified based on the second indexing information and the classification criterion.

3. The electronic apparatus as claimed in claim 2, wherein the processor is configured to apply a preset hash function to the target information to acquire a first hash value, and homomorphically encrypt the first hash value using the public key or the secret key to generate the homomorphic ciphertext, and
apply a preset hash function to the query to generate the second indexing information based on the acquired second hash value.

4. The electronic apparatus as claimed in claim 2, wherein the processor is configured to randomly generate a plurality of Gaussian vectors, and generate the first indexing information by combining results of performing an inner product operation on the plurality of Gaussian vectors with the target information, respectively, and
randomly generate the plurality of Gaussian vectors, and generate the second indexing information by combining the results of performing the inner product operation on the plurality of Gaussian vectors with the query, respectively.

5. The electronic apparatus as claimed in claim 2, wherein the processor is configured to compare a plurality of preset elements among the respective elements of the vector corresponding to the target information with a preset threshold to generate the first indexing information including a result of counting the number of elements having a size greater than or equal to the threshold, and
compare the plurality of preset elements among the respective elements of the vector corresponding to the query with the preset threshold to generate the second indexing information including a result of counting the number of elements having the size greater than or equal to the threshold.

6. The electronic apparatus as claimed in claim 2, wherein the processor is configured to generate a plurality of points and generate the first indexing information based on a point closest to the target information in linear distance, and
generate the second indexing information based on the point closest to the query in linear distance.

7. The electronic apparatus as claimed in claim 2, wherein the processor is configured to generate the first indexing information including a plurality of bits having different bit values according to a sign of each element of the vector corresponding to the target information, and
generate the second indexing information including a plurality of bits having different bit values according to a sign of each element of the vector corresponding to the query.

8. The electronic apparatus as claimed in claim 2, wherein the processor is configured to generate the first indexing information including index path information for specifying an indexing range corresponding to the target information within an entire index hierarchy of the server apparatus.

9. The electronic apparatus as claimed in claim 8, wherein when information on a plurality of classification criteria stored in an encrypted state in the server apparatus is received via the communication interface,
the processor is configured to decrypt the plurality of classification criteria using the secret key, and
generate the second indexing information including one classification criterion closest to the query among the decrypted classification criteria, and transmit the query and the second indexing information to the server apparatus via the communication interface.

10. A server apparatus, comprising:
a communication interface;
a memory storing a plurality of pieces of homomorphically encrypted target information and a plurality of identifiers corresponding to the plurality of pieces of target information; and
a processor,
wherein the processor is configured to:
when a query is received from an electronic apparatus via the communication interface, specify an indexing range based on preset classification criteria, and operate the pieces of target information within the indexing range among the plurality of pieces of target information and the query, respectively,
transmit an operation result to the electronic apparatus via the communication interface, and
when information on an order of the target information corresponding to the query within the operation result is received from the electronic apparatus, transmit an identifier corresponding to the order to the electronic apparatus via the communication interface.

11. The server apparatus as claimed in claim 10, wherein the processor is configured to store, in the memory, a matching table in which the plurality of identifiers and the order of the target information corresponding to each identifier are matched,
when the query and indexing information corresponding to the query are received, identify the pieces of target information within the indexing range corresponding to the indexing information based on the matching table, and
perform an inner product operation on the identified target information and the query; and transmit an operation result of combining inner product operation result values to the electronic apparatus via the communication interface.

12. The server apparatus as claimed in claim 10, wherein when first indexing information including a first homomorphic ciphertext corresponding to new target information and index path information for designating an indexing range corresponding to the first homomorphic ciphertext within an entire index hierarchy classifying the plurality of pieces of target information is received from the electronic apparatus,
the processor is configured to store the received first homomorphic ciphertext in the memory based on the first indexing information, and
when a new query for searching an identifier of the new target information and second indexing information corresponding to the new query are received,
identify an indexing range to be searched within the entire index hierarchy based on the classification criterion and the second indexing information, perform the inner product operation on the pieces of target information included in the identified indexing range and the query, and transmit an operation result of combining the inner product operation result values to the electronic apparatus via the communication interface.

13. A data processing method of an electronic apparatus, comprising:
generating a public key and a secret key for homomorphic encryption, respectively, and storing the public key and secret key;
transmitting a homomorphic ciphertext obtained by encrypting target information using the public key or the secret key and first indexing information for the homomorphic ciphertext to a server apparatus;
transmitting a query for searching for an identifier of the target information and second indexing information for the query to the server apparatus;
when an operation result between pieces of information within a range corresponding to the second indexing information among a plurality of pieces of information stored in the server apparatus and the query is received from the server apparatus, decrypting the operation result using the secret key; and
identifying an order of the target information based on the decrypted operation result and transmitting information on the identified order to the server apparatus to acquire an identifier corresponding to the target information.

14. The data processing method as claimed in claim 13, wherein the transmitting of the homomorphic ciphertext and first indexing information for the homomorphic ciphertext to the server apparatus includes applying a preset hash function to the target information to acquire a first hash value and homomorphically encrypting the first hash value using the public or secret key to generate the first homomorphic ciphertext.

15. A data processing method of a server apparatus, comprising:
storing a plurality of pieces of homomorphically encrypted target information and a plurality of identifiers corresponding to the plurality of pieces of target information;
when a query and indexing information corresponding to the query are received from an electronic apparatus, operating pieces of target information within a range corresponding to the indexing information among the plurality of pieces of target information and the query, respectively, and transmitting the operation result to the electronic apparatus; and
when information on an order of the target information corresponding to the query within the operation result is received from the electronic apparatus, transmitting an identifier corresponding to the order to the electronic apparatus.

16. The data processing method as claimed in claim 15, further comprising:
when first indexing information including a first homomorphic ciphertext corresponding to new target information and index path information for designating an indexing range corresponding to the first homomorphic ciphertext within an entire index hierarchy classifying the plurality of pieces of target information is received from the electronic apparatus,
storing the received first homomorphic ciphertext and the first indexing information based on the first indexing information; and
when a new query for searching an identifier of the new target information and second indexing information corresponding to the new query are received,
identifying an indexing range to be searched within the entire index hierarchy based on the second indexing information, performing the inner product operation on the pieces of target information included in the identified indexing range and the query, and transmitting an operation result of combining the inner product operation result values to the electronic apparatus.
